(19) United States
(12) Patent Application Publication
(10) Pub. No.: US 2019/0218422 A1
(43) Pub. Date: Jul. 18, 2019

(54) WEAR-RESISTANT ADHESIVE TAPE

(71) Applicant: certoplast Technische Klebebaender GmbH, Wuppertal (DE)

(72) Inventors: Rene RAMBUSH, Wuppertal (DE); Timo LEERMANN, Wuppertal (DE)

(21) Appl. No.: 16/241,578

(22) Filed: Jan. 7, 2019

(30) Foreign Application Priority Data
Jan. 17, 2018 (DE) 202018100248.1

(51) Int. Cl. C09J 7/21; D06N 3/12; D06N 3/00

(52) U.S. Cl. CPC C09J 7/21; D06N 3/12; D06N 3/0006; C09J 2203/302; D06N 3/0034; D06N 2201/0263; D06N 3/0036

(57) ABSTRACT

A wear-resistant adhesive tape for wrapping cables in an automobiles. The tape is a textile support strip made of warp yarns and weft yarns and in which each of the yarns is made of polyester or polyamide with a yarn fineness of at least 40 dtex. An adhesive coating is provided on at least one face of the strip. The warp yarns are formed as multi-warp yarns or the weft yarns are formed as multi-weft yarns.

### FIELD OF THE INVENTION

The present invention relates to adhesive tape. More particularly this invention concerns a wear-resistant but manually tearable adhesive tape such as used for wrapping automotive cables.

### BACKGROUND OF THE INVENTION

A typical wear-resistant tape for wrapping cables in automobiles has a textile support strip made of warp yarns and weft yarns. Each of the yarns is made of polyester or polyamide with a yarn fineness of at least 40 dtex, and an adhesive coating is provided on at least one face.

Such an adhesive wrapping tape in particular is used in the automotive sector to bundle cables, thus enabling different cable sets to be produced. Such textile adhesive tapes have additional functions in addition to this quasi consolidating function. Moreover, given the temperatures encountered in automotive applications, which can range for example from −40° C. to +80° C., such adhesive tapes must be temperature-stable. In addition, they must be sufficiently resistant to media such as for example oil and gasoline. What is more, it is important to protect the cables from abrasion and to minimize rattling or vibration noises.

The wear-resistant adhesive tapes the present application is concerned with are those that satisfy at least abrasion class C and frequently abrasion class D according to the LV312 standard “Adhesive tapes for cable sets in motor vehicles” (1/2005) as a common test guideline of the companies Audi, BMW, Daimler, and VW. The abrasion resistance according to LV312 in question is determined in accordance with DIN ISO 6722 by first adhering the tape to be tested to a mandrel (metal rod) having a diameter of 5 mm or 10 mm. Using a scraper tool with a 0.45 mm needle diameter, the number of strokes required to wear through the adhesive tape under a force of 7 N is then determined.

In any case, wear-resistant adhesive tapes in the context of the present application with an adhesive coating on at least one face are those that satisfy at least abrasion class C, generally abrasion class D, and usually even abrasion class E on a mandrel with a 5 mm diameter as well as on a mandrel with a 10 mm diameter according to LV312. Further details on the measurement of abrasion resistance and the classification into the various abrasion classes are described in for example category-defining U.S. Pat. No. 7,993,827. This is a cable wrap in which the textile support tape consists of a single layer formed from a woven textile. A yarn made of a polyamide material having a yarn or thread thickness or fineness of at least 280 dtex is used as the textile. Due to the required yarn thickness that is required on the one hand and in view of the required material (polyamide) on the other, such yarns are relatively expensive and cost-intensive. Certainly, the aim here is to satisfy abrasion class E overall according to LV312. However, the associated effort and expense are substantial.

In the context of applicant's WO 2017/198398, which is also of this generic type, an effort was made further develop the teaching according to U.S. Pat. No. 7,993,827 in order to provide a high level of abrasion resistance on the one hand and the manual tearability that is required for handling the adhesive tapes on the other. After all, the adhesive tape according to U.S. Pat. No. 7,993,827 cannot be torn by hand.

For this reason, WO 2017/198398 proposes a cable-wrapping tape in which the weft yarns have a fineness of greater than 200 dtex and the warp yarns have a fineness of from 40 dtex to 100 dtex. The weft yarns have a high tensile strength overall and a fineness-based maximum tensile force of more than 5 cN/dtex. Both the required abrasion resistance and manual tearability are thus provided.

The teaching according to applicant's US 2017/0198418, which is also of this generic type for the most part, takes a different approach. Here again, specially designed weft yarns are used. Namely, the weft yarns have a twist of more than 180 turns per meter of weft yarn. This has proven successful in principle but requires an additional process for twisting the filament yarns used.

### OBJECTS OF THE INVENTION

It is therefore an object of the present invention to provide an improved wear-resistant adhesive tape.

Another object is the provision of such an improved wear-resistant adhesive tape that overcomes the above-given disadvantages, in particular that is designed to be as manually tearable as possible and to offer advantages over previous embodiments with respect to the associated manufacturing costs.

### SUMMARY OF THE INVENTION

A wear-resistant adhesive tape for wrapping cables in an automobiles. The tape is a textile support strip made of warp yarns and weft yarns, and each of the yarns is made of polyester or polyamide with a yarn fineness of at least 40 dtex. An adhesive coating is provided on at least one face of the strip. According to the invention, the warp yarns are formed as multi-warp yarns or the weft yarns are formed as multi-weft yarns.

The term “multi-weft” refers to the use of a plurality of separate individual yarns that extend parallel to and run along the exact same path as one another, are not attached to one another, and are not wound or twisted about one another, although the individual yarns can themselves be twisted yarns formed from more than one filament.

Thus, the invention uses a special textile construction. Specifically, multiple yarns, i.e. multi-weft yarns and/or multi-warp yarns, are used here in the textile. In principle, such multiple yarns, and multi-weft yarns in particular, can be incorporated into a textile by a modified loom, as known in the art and described for example in greater detail in U.S. Pat. No. 3,482,606. Storage is provided here for the purpose of briefly holding the individual weft yarns. With the aid of a thruster, the weft yarns can each be ejected from nozzles into the shed formed by the warp yarns. Thus with each actuation of the yarn and beating-in of the weft, at least two parallel weft filaments are incorporated into the weave.

In a textile with single warp yarns, for example, two weft yarns can be projected in this way into a shed of the warp yarns. In addition to such a design with double weft yarns as the simplest form of multi-weft yarns, embodiments with more than two weft yarns, with for example up to 10 weft yarns (or even more), are of course also conceivable. The individual weft yarns of the respective multi-weft yarn run parallel to each other but without mutual influence or mechanical interconnection. It is thus possible to work with relatively “thin” weft yarns while still achieving substantial abrasion resistance of the adhesive tape according to the invention, namely by working with the multi-weft yarns, for example.

In fact, it has been found to be especially advantageous in the context of the invention if the textile support tape is composed of single warp yarns and multi-weft yarns. In this way, the invention takes into account the fact that the required abrasion resistance, at least that of class C according to LV312, is already achieved if for example at least double weft yarns and single warp yarns of the respectively specified yarn fineness or yarn thickness are used. After all, by virtue of the fact that each of the yarns has a fineness of at least 40 dtex, double weft yarns already have a yarn thickness or yarn fineness of 80 dtex, for example. In the case of triple weft yarns, a yarn thickness of at least 120 dtex is observed, and for example quadruple weft yarns exhibit a yarn thickness of 160 dtex.

In contrast, the single warp yarns may possess a yarn thickness of at least 100 dtex. At the same time, this configuration ensures that, within certain limits, the wear-resistant adhesive tape produced in this way is still manually tearable or can still be designed to be manually tearable. In fact, owing to the configuration of the warp yarns as single warp yarns, tearing forces in the direction of the weft yarns for tearing the warp yarns can be on the order of about 10 N/cm of transverse width. After all, the yarn thickness or yarn fineness of the single warp yarns is at least 100 dtex in this case. In contrast, the weft yarns can be provided with a greater yarn thickness or yarn fineness of 120 dtex, 160 dtex, etc. In this way, the triple weft yarns or quadruple weft yarns in the example provide primarily for the desired abrasion resistance, similar to that observed in the cable wrapping tape with the weft yarns having high tensile strength according to WO 2017/198398 or in the teaching of US 2017/1198418 as a result of the twist of the weft yarns here.

Since such multi-weft yarns can be implemented in an especially cost-effective manner during manufacture of a corresponding textile, the invention makes it possible to achieve the required abrasion resistance of at least class C according to LV312 on a 5 mm mandrel and 10 mm mandrel on the one hand and to combine this with a still existent manual tearability at low manufacturing cost. What is more, the yarns made of polyester or polyamide inherently satisfy the other requirements in terms of temperature and media resistance, so that an adhesive tape with particularly advantageous effects is provided.

Another aspect of this is that, as a rule, the yarns are made of the same material, that is, the warp yarns and weft yarns are made of either polyester or polyamide. This makes it easy to recycle the wear-resistant adhesive tape. In principle, of course, it is also possible to work with yarns made of different materials, such as with warp yarns made of polyester and weft yarns made of polyamide, or vice versa. It is even conceivable for the warp yarns to be made alternately of polyester and polyamide. The same can apply to the weft yarns.

Textile support tapes with multi-weft yarns are already used in practice in connection with the production of airbag textiles, as evidenced by DE 10 2005 022 567. However, the local textile structure is complicated and is also characterized in that both single weft and multi-weft yarns are used in the same textile. In contrast, the invention consistently works with the same number for the warp yarns and the weft yarns. In other words, if single warp yarns and multi-weft yarns are used here, and advantageously, to execute the textile support tape, for example, only double weft yarns, triple weft yarns, quadruple weft yarns, etc., are used. That is, the number of weft yarns per pick is not varied, although that is also possible in principle. After all, the wear-resistant adhesive tape according to the invention requires a textile support tape having the same properties throughout that can also be produced in a particularly cost-effective manner. It is for this reason that the same number is used for the multi-weft yarns in the textile support tape for each pick.

In order to achieve a particularly high level of abrasion resistance and at least abrasion class D according to LV 312 both on a 5 mm mandrel and on a 10 mm mandrel, the single warp yarns generally have a yarn thickness of at least 200 dtex in the advantageous embodiment. In particular, the single warp yarns can also be provided with a yarn thickness of 400 dtex and more. For example, the invention can use warp yarns each having a yarn thickness or yarn fineness of 470 dtex. In that case, the warp yarns are composed of 40 to 80 filaments, for example. Preferably, 68 filaments are used in this context.

The single warp yarns are generally made of polyamide. Polyamide (PA) 66 in particular, i.e. a polyamide material appropriately classified with the abbreviation PA 66 according to ISO 1043/DIN 7728, has proven to be especially advantageous. The multi-weft yarns are at least double weft yarns, that is, two weft yarns running parallel to each other and not mechanically or otherwise interconnected.

Each of the yarns of each multi-weft yarn has a yarn thickness or yarn fineness of 80 dtex (double weft yarn) or 120 dtex (triple weft yarn), 160 dtex (quadruple weft yarn), etc. After all, the individual weft yarn has a yarn fineness of at least 40 dtex. Moreover, the invention recommends that each of the multi-weft yarns have a yarn thickness of no more than 250 dtex. In fact, the yarn thickness of the individual weft yarns of each multi-weft yarn is usually 235 dtex. The weft yarns of the multi-weft yarn can consist for example of 30 to 60 filaments. In any case, the above-mentioned maximum limit of 250 dtex for each individual weft yarn ensures that the weft yarns in question can still be processed without any difficulty and without modification during manufacture of the weave and shot into the sheds of the warp yarns as described.

The invention recommends polyamide as a material for the manufacture of multi-weft yarns. In principle, of course, it is also possible to work with polyester, as has already been described. Mixtures are also conceivable.

### BRIEF DESCRIPTION OF THE DRAWING

The above and other objects, features, and advantages will become more readily apparent from the following description, reference being made to the accompanying drawing in which:

FIG. 1 is a simplified plan view of a detail of an adhesive tape according to the invention; and

FIG. 2 is an end view of the simplified detail shown in FIG. 1.

### SPECIFIC DESCRIPTION OF THE INVENTION

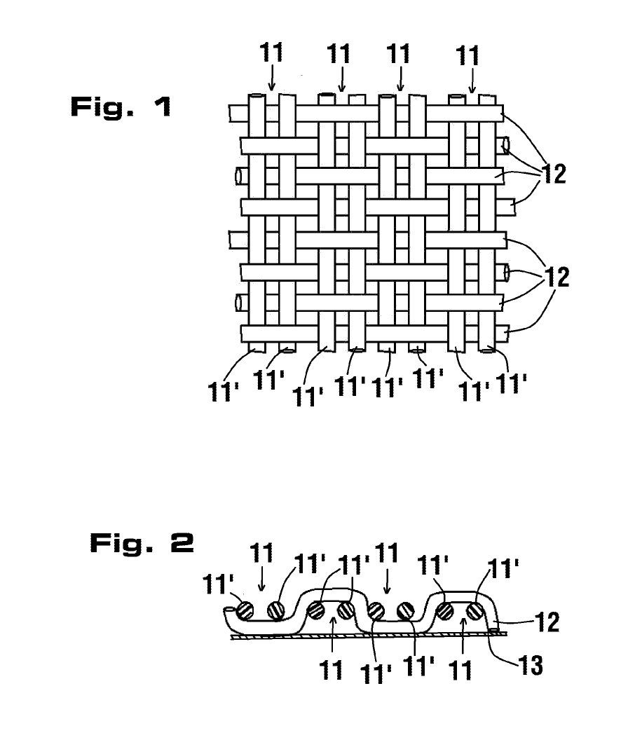

As seen in FIGS. 1 and 2, a textile support tape in accordance with the invention is form of a multiplicity of parallel and transversely spaced warp filaments 12 into which are woven a plurality of longitudinally spaced multi-weft filaments 11. Each such multi-weft filament 11 is formed by a pair of separate weft filaments 11′ that extend parallel to each other, are not connected to each other, and are not twisted or wound around each other. Both yarns 11′ of each multi-weft yarn 11 follow the same transverse path across the strip, under and over the succeeding warp filaments 12 as clearly shown in FIGS. 1 and 2. One face of the tape thus formed is covered by a layer 13 of adhesive.

The tape of this invention generally contains from 10 warp yarns/cm to 50 warp yarns/cm. In most cases 20 warp yarns/cm has proven to be particularly expedient here. As for number of weft yarns in the textile support tape, 10 weft yarns per cm to 80 wefts per cm is recommended. If double weft yarns are used, this means that the textile support tape is provided with from 5 double weft yarns/cm to 40 double weft yarns/cm in this case. In fact, the 5 double weft yarns/cm corresponds to 10 individual weft yarns/cm, while 40 double weft yarns/cm corresponds to 80 individual weft yarns/cm if every single weft yarn is counted.

The weight per unit area of the textile support tape is generally between 150 g/m² and 250 g/m². Weights per unit area in the range of about 185 g/m² are generally used here. In order to keep manufacturing costs particularly low, the textile support tape generally consists of a single layer of fabric. Furthermore, in addition to this single textile layer, there is only an adhesive coating 13 that is formed as a self-adhesive pressure-sensitive adhesive layer applied to one face to the textile support tape. The adhesive coating 13 in question is usually made from an acrylate-based adhesive. This can be done by known coating techniques such as die coating, curtain coating, etc. The specific weight per unit area of the adhesive coating 13 or of the pressure-sensitive adhesive on the textile support tape is generally in the range between 50 g/m² and 200 g/m².

All in all, it is thus possible to make a wear-resistant adhesive tape that satisfies at least abrasion class C according to LV 312 on a 5 mm mandrel and a 10 mm mandrel. As a rule, even abrasion class D is met. Also, depending on the configuration and selected yarn thickness for the warp yarns and weft yarns and on the number of individual parallel weft yarns in the execution of the respective multi-weft yarn, abrasion resistances of up to class E can also be achieved. All of this is achieved in consideration of an especially cost-effective construction. Moreover, the manual tearability of the wear-resistant adhesive tape according to the invention is still also maintained to a certain extent. Herein lie the fundamental advantages.

We claim:

1. A wear-resistant adhesive tape for wrapping cables in an automobiles, wherein:
the tape is a textile support strip made of warp yarns and weft yarns,
each of the yarns is made of polyester or polyamide with a yarn fineness of at least 40 dtex,
at least one face of the strip is provided with an adhesive coating, and
the warp yarns are formed as multi-warp yarns or the weft yarns are formed as multi-weft yarns.

2. The tape defined in claim 1, wherein the textile support strip is composed of single warp yarns and multi-weft yarns, the multi-weft yarns each being composed of at least two individual yarns.

3. The tape defined in claim 2, wherein the single warp yarns have a yarn thickness of at least 200 dtex.

4. The tape defined in claim 2, wherein the single warp yarns are of polyamide.

5. The tape defined in claim 2, wherein the multi-weft yarns are double-weft yarns each having two individual yarns.

6. The tape defined in claim 5, wherein the individual yarns of each multi-weft yarn run parallel to and along the exact same path as each other, are not connected to each other, and are not wound or twisted around each other.

7. The tape defined in claim 2. wherein the individual yarns of the multi-weft yarns each have a yarn thickness of greater than 200 dtex.

7. The tape defined in claim 2, wherein each of the individual yarns of the multi-weft yarns has a yarn thickness of no more than 250 dtex.

9. The tape defined in claim 2, wherein the multi-weft yarns are made of polyamide.

10. The tape defined in claim 1, wherein 10 to 50 warp yarns/cm are provided in the textile support strip.

11. The tape defined in claim 1, wherein 10 to 80 weft yarns/cm are provided in the textile support strip.

12. The tape defined in claim 10, wherein the 10 to 80 weft yarns/cm corresponds to 5 to 40 double weft yarns/cm in the textile support strip.

13. The tape defined in claim 1, wherein a weight per unit area of the textile support strip is between 150 g/m² and 250 g/m².

14. The tape defined in claim 1, wherein the textile support strip consists of a single layer of fabric.

15. The tape defined in claim 1, wherein the adhesive coating is a self-adhesive pressure-sensitive adhesive coating applied to the one face of the textile support strip.

16. The tape defined in claim 15, wherein the adhesive coating is made from an acrylate-based adhesive.
